(19) United States
(12) Patent Application Publication
(10) Pub. No.: US 2020/0071186 A1
(43) Pub. Date: Mar. 5, 2020

(54) Linear Porous Titanium Dioxide Material And Preparation And Use Thereof

(71) Applicant: PetroChina Company Limited, Beijing (CN)

(72) Inventors: Jianming Li, Beijing City (CN); Xu Jin, Beijing City (CN); Xiaoqi Wang, Beijing City (CN); Xiaodan Liu, Beijing City (CN); Hang Jiao, Beijing City (CN); Liang Sun, Beijing City (CN); Ling Su, Beijing City (CN)

(21) Appl. No.: 16/555,147

(22) Filed: Aug. 29, 2019

(30) Foreign Application Priority Data
Aug. 30, 2018 (CN) 201811001842.3

(51) Int. Cl. C01G 23/08; C01G 23/053; B01J 21/06; B01J 35/00; B01J 37/04; B01J 37/03; B01J 37/08; H01M 4/485

(52) U.S. Cl. CPC C01G 23/08; B01J 35/1061; C01G 23/0532; C01G 23/0536; B01J 21/063; B01J 35/004; B01J 35/0013; B01J 37/04; B01J 37/033; B01J 37/082; H01M 4/485; C01P 2004/16; C01P 2006/16; C01P 2004/03; C01P 2004/04; C01P 2002/74; C01P 2002/85; C01P 2006/40; C01G 23/053

(57) ABSTRACT

The present invention provides a linear porous titanium dioxide material and the preparation and products thereof. The linear porous titanium dioxide material has an anatase phase structure and a single crystal structure, and the structure of the linear porous titanium dioxide material is composed of a plurality of particles having an oriented growth direction. The invention also provides a method of preparing the above material and the use thereof. The long axis of structure of the titanium dioxide porous nanowire of the present invention facilitates effective electron migration.

### RELATED APPLICATION

This application claims priority under 35 U.S.C. § 119 or 365 to China Application No. 201811001842.3, filed Aug. 30, 2018. The entire teachings of the above application is incorporated herein by reference.

### TECHNICAL FIELD

The invention relates to a linear porous titanium dioxide material and the preparation and use thereof, which pertains to the field of semi-conductive functional materials and material preparation.

### BACKGROUND

Titanium dioxide is a hot research topic in the field of materials due to its broad application prospects in water photolysis, catalysis, photocatalysis, lithium ion batteries, sodium ion batteries, potassium ion batteries, dye-sensitized solar cells and sensors, etc.

The applied properties of anatase phase titanium dioxide are closely related to its morphology. For example, as compared to titanium dioxide nanoparticles, the linear structure of titanium dioxide nanomaterials can reduce the grain boundary between particles and facilitate the transport of carriers in the long axis direction, which has the following advantages: (1) in the field of photocatalysis, the linear structure facilitates the free migration of photogenerated electron-hole pairs in the long axis direction, reduces the probability of electron-hole recombination, and improves the photocatalytic efficiency; (2) in the field of battery electrode materials, the linear long axis is beneficial to effective electron migration, while the short axis facilitates the rapid intercalation and deintercalation of lithium, sodium, or potassium ions, and the linear structure has better charging and discharging performance than the nanoparticles; (3) in the field of dye-sensitized solar cell, the linear structure can reduce the grain boundary between particles, which facilitates the transport of electrons on the photo-anode and greatly improves battery efficiency.

Both experimental and theoretical calculations show that the highly-active {100} and {001} crystal planes have higher crystal plane energy than the {101} crystal plane. Anatase phase titanium dioxide with highly-active crystal planes (such as the {100} or {001} crystal plane) exposed can exhibit better applied effects such as photocatalysis. A thermodynamically-stable anatase phase titanium dioxide tends to form a small number of truncated octahedral particles, i.e., particles consisted of eight low activity {101} crystal planes and two highly-active {001} crystal planes. Among them, the {101} crystal planes accounts for as high as up to 94% and tends to easily vanish in the growing process of the material, primarily due to the properties including high activity and low stability of the high-activity crystal planes. Therefore, it is very likely that the {101} crystal plane with low activity of the anatase phase titanium dioxide is exposed in the growing process to form octahedral particles. Currently, nothing has been reported on linear anatase phase titanium dioxide materials having a large proportion of active {100} and {001} crystal planes.

In addition, porous titanium dioxide materials have a large specific surface area and a high porosity which provide them with many excellent properties in application. The specific surface area and active sites of porous titanium dioxide may increase drastically, which greatly accelerates reaction on its surface and its interaction with media, and improves the applied properties of the material. A titanium dioxide material with a porous structure has high light absorption and light scattering utilization, and, in general, anatase phase titanium dioxide having a porous structure exhibits high photocatalytic efficiency. However, the porous titanium dioxide materials reported insofar are in granular forms, such as porous spheres, porous crystalline nanoparticles and the like, having a large grain boundary, and may easily become a recombination center of photogenerated electron-holes.

### SUMMARY OF THE INVENTION

In order to solve the above technical problems, an objective of the present invention is to provide a linear porous titanium dioxide material and the preparation method thereof, by which an anatase phase titanium dioxide nanomaterial having a linear, porous, single crystal structure with active crystal planes structure is obtained by combining a linear structure, a single crystal structure, a porous structure, active {100} and {001} crystal planes, thereby greatly increasing the specific surface area of the material, enhancing the surface activity of the material, reducing the grain boundary between particles, improving effective carrier transport in the long axis direction, and enhancing the applied properties of the material.

In order to achieve the above objective, the present invention provides a linear porous titanium dioxide material, wherein the linear porous titanium dioxide material has an anatase phase structure and a single crystal structure; the structure of the linear porous titanium dioxide material is composed of a plurality of particles having an oriented growth direction (i.e., arranged in an oriented direction), preferably a growth direction in the <001> direction.

According to a particular embodiment of the present invention, the linear porous titanium dioxide material is consisted of many small particles. Preferably, the linear porous titanium dioxide material (a structure of an assembly of the particles) has a structure of one or more rectangular columns which have flat side surfaces that are perpendicular to each other.

According to a particular embodiment of the present invention, preferably, the side surfaces of the linear porous titanium dioxide material are highly-active anatase phase {100} and {001} crystal planes.

According to a particular embodiment of the present invention, preferably, the linear porous titanium dioxide material has a linear structure having a diameter of 20 nm to 5 μm and a length of 1 μm to 50 μm; more preferably, the linear porous titanium dioxide material has a linear structure having a diameter of 100 nm to 1,000 nm and a length of 5 μm to 20 μm. According to a particular embodiment of the present invention, preferably, the pores in the linear porous structure of the linear porous titanium dioxide material have a size of 2 nm to 50 nm; more preferably, the pores have a size of 5 nm to 20 nm.

According to a particular embodiment of the invention, preferably, the long-axis of the single crystal of the linear porous titanium dioxide material is oriented in the <010> direction.

The linear porous titanium dioxide material provided by the present invention has a structure that may improve the application effect of the titanium dioxide material in the fields of battery electrodes, catalysis, photocatalysis, sensing, solar cells, hydrophilicity and hydrophobicity, biology and the like.

The present invention also provides a method of preparing the above-mentioned linear porous titanium dioxide material, with the procedure thereof shown in FIG. 8. This preparation method comprises the steps of:

dispersing a titanium source in an aqueous solution of a peroxide containing a lithium compound under stirring to form a solution;

subjecting the solution to a heating reaction to obtain lithium titanate peroxide having a linear structure;

subjecting the lithium titanate peroxide to a low temperature annealing treatment to obtain lithium titanate having a linear structure;

dispersing the lithium titanate in an acid solution for hydrogen ion exchange to obtain titanic acid having a linear structure;

subjecting the titanic acid to heat treatment to obtain the linear porous titanium dioxide material; preferably, the heat treatment includes hydrothermal treatment and/or high temperature annealing.

In the above preparation method, preferably, a polymer is added to the solution while the titanium source is being dispersed in an aqueous solution of a peroxide containing a lithium compound under stirring to form a solution.

The polymer used is one or more selected from chitosan, guar gum, methyl cellulose, ethyl cellulose, hydroxyethyl cellulose, hydroxypropyl cellulose, hydroxypropyl methyl cellulose, polyvinyl alcohol, polyacrylamide, polyethylene oxide, polyethylene glycol, polyvinylpyrrolidone, and the like. In the above-mentioned solution, the amount of polymer added may be controlled at 100 ppm to 100,000 ppm, more preferably 1,000 ppm to 10,000 ppm. The polymer may be added in the form of a solid or an aqueous solution.

In the above preparation method, preferably, the titanium source is one or more selected from titanium ethoxide, titanium propoxide, tetrabutyl titanate, titanium glycolate, titanium glyceroxide, titanium sulfate, titanium oxysulfate, titanium tetrachloride, titanium tetrafluoride, ammonium fluorotitanate, titanium nitride, titanium dioxide, metatitanic acid, orthotitanic acid, and the like.

In the above preparation method, the titanium source may also be titanic acid hydrate; and the titanic acid hydrate is obtained by a hydrolysis reaction of a titanium-containing compound. The titanium-containing compound may be one or more selected from titanium ethoxide, titanium propoxide, tetrabutyl titanate, titanium glycolate, titanium glyceroxide, titanium sulfate, titanium oxysulfate, titanium tetrachloride, titanium tetrafluoride, ammonium fluorotitanate, industrial titanium-containing compounds, and the like. Here, the hydrolysis reaction is conducted by dispersing the titanium-containing compound in pure water for direct hydrolysis to produce the titanic acid hydrate; alternatively, the hydrolysis reaction is conducted by dispersing the titanium-containing compound in an aqueous solution containing an alkali substance for hydrolysis to produce the titanic acid hydrate. The alkali substance is one or more selected from aqueous ammonia, sodium hydroxide, potassium hydroxide, tetramethylammonium hydroxide, tetraethylammonium hydroxide, tetrapropylammonium hydroxide, tetrabutylammonium hydroxide, ethylenediamine, diethylamine, triethylamine, ethylamine, ethanolamine, diethanolamine, and the like. The titanic acid hydrate is obtained by purification after the hydrolysis reaction of the titanium-containing compound; the purification is done to remove impurity ions to obtain a titanic acid hydrate with a purity of 97% or more; the purification may be conducted in a manner of one or more of water washing-centrifuge separation, water washing-membrane separation, water washing-filtration, dialysis, and the like.

In the above preparation method, preferably, the lithium compound in the aqueous solution of the lithium compound-containing peroxide is one or more selected from lithium hydroxide, lithium oxide, lithium peroxide, lithium superoxide, and the like. In the aqueous solution of the lithium compound-containing peroxide, the concentration of the lithium compound may be 0.4 to 1.0 mol/L.

In the above preparation method, preferably, in the aqueous solution of the lithium compound-containing peroxide, the peroxide is one or more selected from hydrogen peroxide, urea peroxide, peracetic acid, and the like. The concentration of the peroxide may be controlled at 0.1 to 2.0 mol/L.

In the above preparation method, preferably, the temperature of the heating reaction is 60 to 100° C.; and the duration of the heating reaction is 0.5 to 24 hours.

In the above preparation method, preferably, the temperature of the low temperature annealing treatment is 150 to 250° C.; and the duration of the low temperature annealing treatment is 1 to 24 hours.

In the above preparation method, preferably, the hydrogen ion exchange includes: washing and separating the lithium titanate having a linear structure; adding the separated lithium titanate having a linear structure in an acid solution for hydrogen ion exchange to obtain a titanic acid having a linear structure, and washing the titanic acid having a linear structure before being separated and dried. Here, the acid solution used may be one or more selected from nitric acid, hydrochloric acid, sulfuric acid, acetic acid, and the like. The concentration of the acid solution may be controlled at 0.001 to 0.1 mol/L.

In the above preparation method, preferably, the temperature of the hydrothermal reaction is 105 to 240° C.; and the duration of the hydrothermal reaction is 1 to 48 hours. The system of the hydrothermal reaction may be one of an acidic system, a neutral system, an alkaline system, and the like.

In the above preparation method, preferably, the temperature of the high temperature annealing is 300 to 1000° C., preferably from 350 to 1000° C.; and the duration of the high temperature annealing treatment is 1 to 24 hours.

The present invention also provides a method for surface modification of the above-mentioned linear porous titanium dioxide material. Preferably, the surface modification comprises one or more of carbon loading, graphene loading, black phosphorus loading, ruthenium oxide loading, lead oxide loading, nickel oxide loading, metal platinum loading, metal gold loading, metal silver loading, and metal copper loading.

The present invention also provides a method for semiconductor compositing of the above linear porous titanium dioxide material; preferably, the semiconductor compositing includes one or more of cadmium sulfide-semiconductor compositing, lead sulfide-semiconductor compositing, copper oxide-semiconductor compositing, cuprous oxide-semiconductor compositing, iron oxide-semiconductor compositing, ferrous oxide-semiconductor compositing, tungsten oxide-semiconductor compositing, zinc oxide-semiconductor compositing, gallium phosphide-semiconductor compositing, cadmium stannide-semiconductor compositing, molybdenum sulfide-semiconductor compositing, carbon nitride-semiconductor compositing, and the like.

The invention also provides the use of the above-mentioned linear porous titanium dioxide material in the field of one or more of lithium ion battery materials, sodium ion battery materials, potassium ion battery materials, catalytic hydrogenation materials, organic pollutant photocatalytic degradation, water photocatalytic decomposition for hydrogen production, gas sensing, dye-sensitized solar cells, perovskite solar cells, hydrophilic and hydrophobic materials, and biomedicines.

The advantages of the present invention are as follows:

The anatase phase titanium dioxide material provided by the present invention has a linear, single crystal, porous structure and active {100} and {001} crystal planes, wherein the porous structure may increase the specific surface area of the titanium dioxide material and increase reactive sites, the linear single crystal structure may reduce the grain boundary between particles, facilitates the transport of carriers in the long axis direction, and improves the applied effect of the material, and exposure of a large number of highly active {100} and {001} crystal planes is favorable to increase the surface activity of the material and improve the applied effect of the material. The preparation method of the anatase phase titanium dioxide material provided by the present invention cannot be realized by other approaches. With a simple production process, easily controllable process parameters and readily available raw materials, this preparation method has low production cost and can be easily scaled up for industrial production.

The titanium dioxide porous nanowire of the present invention has the following advantages in application:

(1) The structure of the titanium dioxide porous nanowire of the invention is favorable for electron-hole separation, increases active sites for catalytic reaction, has high photocatalytic activity, and is favorable for water photolysis for hydrogen generation or photocatalytic degradation of organic pollutants.

(2) The long axis of the structure of the titanium dioxide porous nanowire of the invention facilitates effective electron migration, the porous structure facilitates the rapid intercalation and deintercalation process of lithium ions, sodium ions, or potassium ions, while the large specific surface area is favorable to reduce the contact area between electrolyte and electrodes and lower the current density, providing good battery charging and discharging performance.

(3) The structure of the titanium dioxide porous nanowire of the present invention has a large specific surface area that is capable of adsorbing more dyes while the one-dimensional structure facilitates electron transport, which is advantageous in dye-sensitized solar cells.

(4) The structure of the titanium dioxide porous nanowire of the present invention is favorable for gas sensing, for example, applications in sensing gases such as hydrogen, oxygen, formaldehyde, propane, ethane, methane, carbon monoxide, carbon dioxide, and water vapor.

(5) The titanium dioxide porous nanowire of the present invention has a large specific surface area that is capable of adsorbing a large amount of organic species or heavy metal ions, provide an adsorption and separation effect.

### BRIEF DESCRIPTION OF THE ACCOMPANYING DRAWINGS

FIG. 1 is an SEM image of the titanium dioxide material prepared in Example 1.

FIG. 2 is a TEM image of the titanium dioxide material prepared in Example 1.

FIG. 3 is an XRD pattern of the titanium dioxide material prepared in Example 1.

FIG. 4 is a transmission electron microscopy and electron diffraction pattern of the titanium oxide material prepared in Example 1.

FIG. 5 is an SEM image of the titanium dioxide material prepared in Example 1.

FIG. 6 is a graph showing the hydrogen generation efficiency by photocatalytic water decomposition with the titanium dioxide material prepared in Example 1 using ethanol as a sacrificial agent.

FIG. 7 is a graph showing the hydrogen generation efficiency by photocatalytic water decomposition with the titanium dioxide material prepared in Example 1 using triethanolamine as a sacrificial agent.

FIG. 8 is a diagram of the procedure for preparing a linear porous titanium dioxide material.

### DETAILED DESCRIPTION OF THE INVENTION

The technical solutions in the embodiments of the present invention will be set forth clearly and wholly in the following description of the embodiments of the present invention to provide those skilled in the art a better understanding of the technical solution. Obviously, only some of the embodiments, but not all, of the present invention are illustrated. All other embodiments obtainable by a person of ordinary skill in the art based on the embodiments of the present invention without making creative efforts are intended to be encompassed in the scope of the present invention.

Unless otherwise defined, all technical and scientific terms used herein have the same meaning as commonly understood by one of ordinary skill in the art to which this invention belongs. The terminology used in the description of the present invention is for the sole purpose of illustrating particular embodiments and is not intended to limit the invention. The term “and/or” as used herein includes any and all combinations of one or more of the associated items listed.

Particular embodiments of the invention are disclosed herein in details with reference to the description hereinafter. It should be understood that the scope of the embodiments of the invention are not limited thereto. Many variations, modifications, and equivalents are included in the embodiments of the present invention without departing from the scope and spirit of the appended claims.

Features described and/or illustrated with respect to one embodiment may be used in one or more other embodiments in the same or similar manner in combination with, or in place of, features in other embodiments.

It should be emphasized that the term “comprise/include” as used herein indicates the presence of a feature, assembly, step, or component, but does not exclude the presence or addition of one or more other features, assembly, steps, or components.

Any numerical value recited herein includes all values between the lower and upper values in increments of one unit from the lower limit to the upper limit, provided an interval of at least two units is present between any lower value and any higher value. For example, if the number of a component or a process variable (e.g., temperature, pressure, time, etc.) is recited to be from 1 to 90, preferably from 20 to 80, more preferably from 30 to 70, it is intended that values such as from 15 to 85, from 22 to 68, from 43 to 51, from 30 to 32 and the like are also explicitly recited in the specification. For values smaller than 1, 0.0001, 0.001, 0.01, 0.1 is appropriately considered as one unit. These are merely examples intended to be expressly illustrated, and all possible combinations of the numerical values listed between the minimum and maximum values are considered to be explicitly recited in the present specification in a similar manner.

All ranges include endpoints and all numbers between the endpoints unless otherwise indicated. “about” or “approximately” as used with a range applies to both endpoints of the range. Thus, “about 20 to 30” is intended to encompass “about 20 to about 30”, including at least the indicated endpoints.

All articles and references disclosed, including patent applications and publications, are hereby incorporated by reference for all purposes. The term “essentially consisted of” that describes a combination shall include the identified elements, components, parts, or steps and other elements, components, parts, or steps that do not have any substantial impact on the fundamental novel features of the combination. When using the term “comprise/include” or “comprising/including” to describe a combination of the elements, components, parts, or steps, embodiments that are essentially consisted of these elements, components, parts, or steps are also contemplated. Herein, by using the term “may”, it is intended to indicate that any of the attributes described as “may” are optional.

A plurality of elements, components, parts, or steps can be provided in a single integrated element, component, part, or step. Alternatively, a single integrated component, component, part, or step may be divided into elements, components, parts, or steps. The use of the term “a” or “an” is not intended for exclusion of other elements, components, parts, or steps.

The principle of the present invention is described in details below with reference to a number of embodiments.

### EXAMPLE 1

This example provides a method of preparing a linear porous titanium dioxide material, which comprises the following steps:

1 g of titanium sulfate was dispersed and dissolved under stirring in 100 ml of an aqueous solution to form a solution, and aqueous ammonia at a concentration of 0.1 mol/L was slowly added dropwise to the above solution until the solution was neutral (about pH 7). The titanium sulfate was gradually and completely hydrolyzed to form a titanic acid hydrate precipitate, and the titanic acid hydrate precipitate was ultrasonically dispersed, washed with deionized water for several times, and then separated by centrifugation.

Next, hydrogen peroxide and lithium hydroxide were dissolved in water to a lithium hydroxide concentration of 0.6 mol/L and a hydrogen peroxide concentration of 0.8 mol/L. Subsequently, the above titanic acid hydrate precipitate upon centrifugation was dispersed in 100 ml of the hydrogen peroxide aqueous solution containing lithium hydroxide prepared as above, and a clear yellow solution was formed under stirring. Then, this clear yellow solution was heated to 80° C. and kept at constant temperature under stirring for 6 hours, the reaction was terminated, and a white solid was obtained after separation. Subsequently, the above white solid was dried and placed in an oven at 220° C. for annealing treatment for 12 hours to remove any hydrogen peroxide adsorbed or included in the white solid. Then, the treated white solid was washed with deionized water for several times and placed in a 0.01 mol/L nitric acid solution for hydrogen ion exchange. After hydrogen ion exchange, the solid was washed with deionized water for several times until the pH of the washing solution was close to neutral and then dried.

Finally, the dried white solid was placed in a muffle furnace and annealed at 650° C. for 3 hours to obtain an anatase phase linear porous titanium dioxide material.

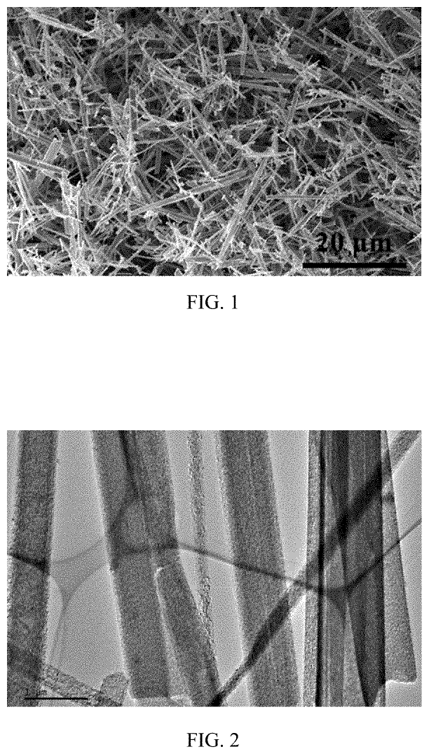

The SEM image of the titanium dioxide material prepared in this example is shown in FIG. 1. As can be seen from FIG. 1, the titanium dioxide material is linear, with a diameter of 20 nm to 5 μm, mostly populated within 100 nm to 1000 nm, and a length of 1 μm to 50 μm, mostly populated within 5 μm to 20 μm.

The TEM image of the titanium dioxide material prepared in this example is shown in FIG. 2. As can be seen from FIG. 2, the titanium dioxide material has a porous structure, with a pore size of about 5 nm to 20 nm.

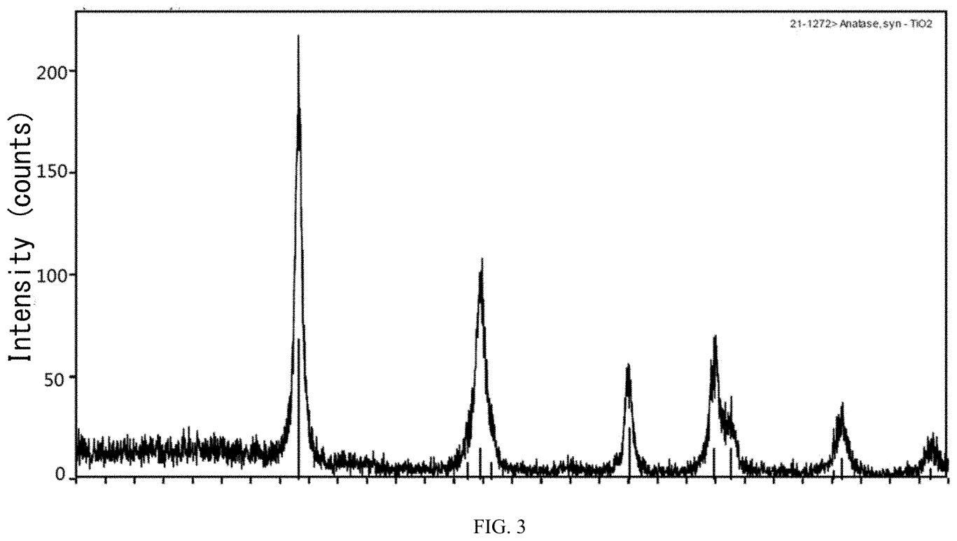

The XRD pattern of the titanium dioxide material prepared in this example is shown in FIG. 3. As can be seen from FIG. 3, the linear porous titanium dioxide material of this example has an anatase phase structure.

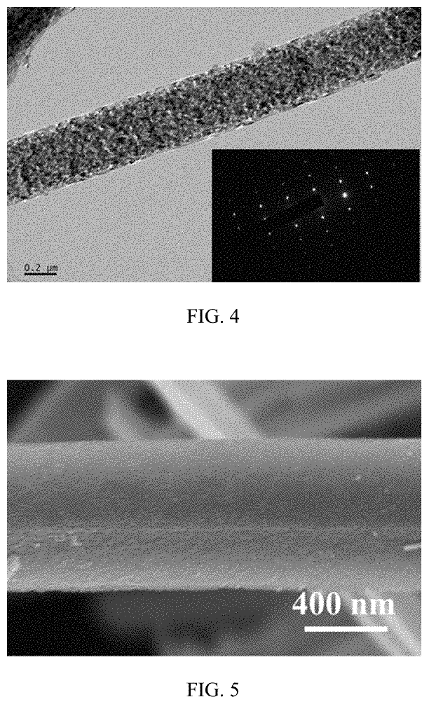

The transmission electron microscopy and electron diffraction pattern of the titanium dioxide material prepared in this example is shown in FIG. 4. As can be seen from FIG. 4, the titanium dioxide material of this example has a single crystal structure, and the long axis of the single crystal is oriented in the <010> direction. The linear porous structure is consisted of a plurality of small particles, and the particles have an oriented growth direction.

A high-magnification SEM image of the titanium dioxide material prepared in this example is shown in FIG. 5. As can be seen from FIG. 5, the titanium dioxide material of this example has a structure of one or more rectangular columns which have flat side surfaces that are perpendicular to each other, the side surfaces being highly-active anatase phase {100} and {001} crystal planes.

It can be seen from the above results that the titanium dioxide material prepared in this example is a linear porous anatase phase single crystal titanium dioxide material and has a structure of one or more rectangular columns.

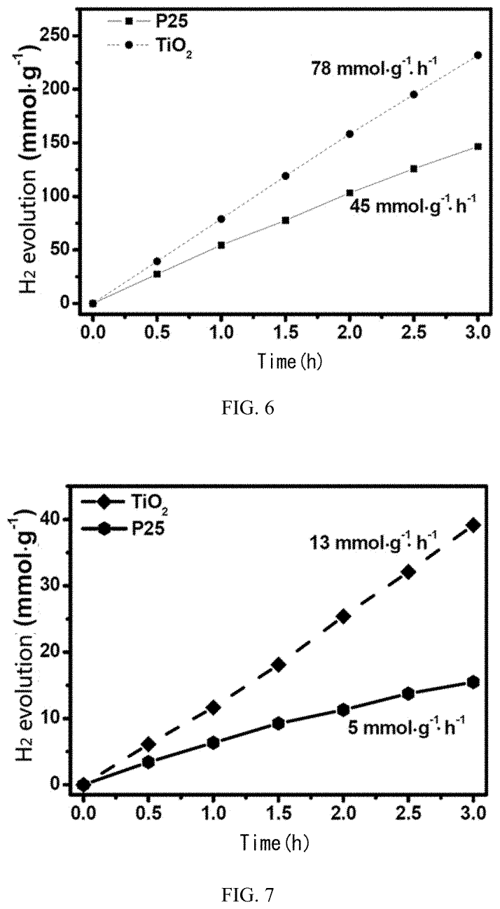

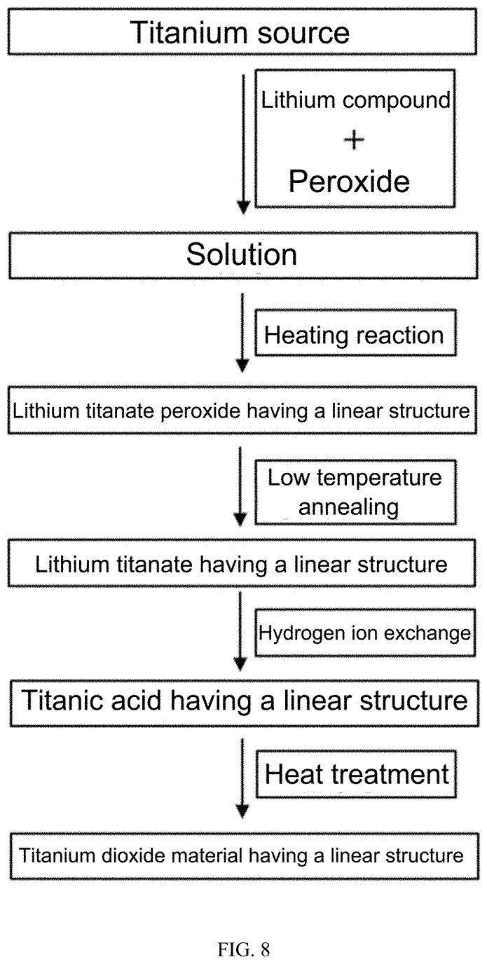

The hydrogen generation efficiency by photocatalytic water decomposition with the titanium dioxide material prepared in this example is shown in FIG. 6. The hydrogen generation efficiency by photocatalytic water decomposition was determined as follows: 50 mg of the sample was added to 90 mL of water, followed by addition of chloroplatinic acid with a mass ratio of platinum to titanium dioxide of 5,000 ppm; after irradiation for 30 minutes with a simulated sun light source, 10 mL of ethanol was added and the amount of the hydrogen generated was calculated. As seen from FIG. 6, when ethanol is used as the sacrificial agent, the hydrogen generation efficiency under standard sun light irradiation is as high as 78 mmol·g⁻¹·h⁻¹, which is 1.7 times higher as compared to a commercial P25 material.

The hydrogen generation efficiency by photocatalytic water decomposition with the titanium dioxide material prepared in this example is shown in FIG. 7. The hydrogen generation efficiency by photocatalytic water decomposition was determined as follows: 50 mg of the sample was added to 90 mL of water, followed by addition of chloroplatinic acid with a mass ratio of platinum to titanium dioxide of 5,000 ppm; after irradiation for 30 minutes with a simulated sun light source, 10 mL of triethanolamine was added and the amount of the hydrogen generated was calculated. As seen from FIG. 6, when triethanolamine is used as the sacrificial agent, the hydrogen generation efficiency under standard sun light irradiation is as high as 13 mmol·g⁻¹·h⁻¹, which is 2.6 times higher as compared to a commercial P25 material.

### EXAMPLE 2

This example provides a method of preparing a linear porous titanium dioxide material, which comprises the following steps: 0.1 g of titanium oxysulfate was dispersed and dissolved under stirring in 100 ml of an aqueous solution to form a solution, and aqueous ammonia at a concentration of 0.01 mol/L was slowly added dropwise to the above solution until the solution was neutral (about pH 7). The titanium oxysulfate was gradually and completely hydrolyzed to form a titanic acid hydrate precipitate, and the titanic acid hydrate precipitate was ultrasonically dispersed, washed with deionized water for several times, and then separated by centrifugation.

Next, hydrogen peroxide and lithium hydroxide were dissolved in water to a lithium hydroxide concentration of 0.4 mol/L and a hydrogen peroxide concentration of 0.1 mol/L. Subsequently, the above titanic acid hydrate precipitate upon centrifugation was dispersed in 100 ml of the hydrogen peroxide aqueous solution containing lithium hydroxide prepared as above, and a clear yellow solution was formed under stirring. Then, this clear yellow solution was heated to 60° C. and kept at constant temperature under stirring for 24 hours, the reaction was terminated, and a white solid was obtained after separation. Subsequently, the above white solid was dried and placed in an oven at 150° C. for annealing treatment for 24 hours to remove any hydrogen peroxide adsorbed or included in the white solid. Then, the treated white solid was washed with deionized water for several times and placed in a 0.001 mol/L hydrochloric acid solution for hydrogen ion exchange. After hydrogen ion exchange, the solid was washed with deionized water for several times until the pH of the washing solution was close to neutral and then dried.

Finally, the dried white solid was placed in a muffle furnace and annealed at 300° C. for 24 hours to obtain an anatase phase linear porous titanium dioxide material.

### EXAMPLE 3

This example provides a method of preparing a linear porous titanium dioxide material, which comprises the following steps: 6 g of titanium tetrachloride was dispersed and dissolved under stirring in 100 ml of an aqueous solution to form a solution, and aqueous ammonia at a concentration of 0.2 mol/L was slowly added dropwise to the above solution until the solution was neutral (about pH 7). The titanium tetrachloride was gradually and completely hydrolyzed to form a titanic acid hydrate precipitate, and the titanic acid hydrate precipitate was ultrasonically dispersed, washed with deionized water for several times, and then separated by centrifugation.

Next, hydrogen peroxide and lithium hydroxide were dissolved in water to a lithium hydroxide concentration of 1.0 mol/L and a hydrogen peroxide concentration of 2.0 mol/L. Subsequently, the above titanic acid hydrate precipitate upon centrifugation was dispersed in 100 ml of the hydrogen peroxide aqueous solution containing lithium hydroxide prepared as above, and a clear yellow solution was formed under stirring. Then, this clear yellow solution was heated to 100° C. and kept at constant temperature under stirring for 0.5 hour, the reaction was terminated, and a white solid was obtained after separation. Subsequently, the above white solid was dried and placed in an oven at 250° C. for annealing treatment for 1 hour to remove any hydrogen peroxide adsorbed or included in the white solid. Then, the treated white solid was washed with deionized water for several times and placed in a 0.1 mol/L acetic acid solution for hydrogen ion exchange. After hydrogen ion exchange, the solid was washed with deionized water for several times until the pH of the washing solution was close to neutral and then dried.

Finally, the dried white solid was placed in a muffle furnace and annealed at 1000° C. for 1 hour to obtain an anatase phase linear porous titanium dioxide material.

### EXAMPLE 4

This example provides a method of preparing a linear porous titanium dioxide material, which comprises the following steps: 2 g of titanium tetrafluoride was dispersed and dissolved under stirring in 100 ml of an aqueous solution to form a solution, and aqueous ammonia at a concentration of 0.1 mol/L was slowly added dropwise to the above solution until the solution was neutral (about pH 7). The titanium tetrafluoride was gradually and completely hydrolyzed to form a titanic acid hydrate precipitate, and the titanic acid hydrate precipitate was ultrasonically dispersed, washed with deionized water for several times, and then separated by centrifugation.

Next, peracetic acid and lithium peroxide were dissolved in water to a lithium peroxide concentration of 0.4 mol/L and a peracetic acid concentration of 1.0 mol/L. Subsequently, the above titanic acid hydrate precipitate upon centrifugation was dispersed in 100 ml of the aqueous solution containing peracetic acid and lithium peroxide prepared as above, and a clear yellow solution was formed under stirring. Then, this clear yellow solution was heated to 70° C. and kept at constant temperature under stirring for 12 hours, the reaction was terminated, and a white solid was obtained after separation. Subsequently, the above white solid was dried and placed in an oven at 200° C. for annealing treatment for 20 hours to remove any hydrogen peroxide adsorbed or included in the white solid. Then, the treated white solid was washed with deionized water for several times and placed in a 0.01 mol/L sulfuric acid solution for hydrogen ion exchange. After hydrogen ion exchange, the solid was washed with deionized water for several times until the pH of the washing solution was close to neutral and then dried.

Finally, the dried white solid was placed in a muffle furnace and annealed at 500° C. for 8 hours to obtain an anatase phase linear porous titanium dioxide material.

### EXAMPLE 5

This example provides a method of preparing a linear porous titanium dioxide material, which comprises the following steps:

Under stirring, 1.5 g of titanium propoxide was dispersed in 100 ml of an aqueous solution prepared by dissolving hydrogen peroxide and lithium hydroxide in water, and a clear yellow solution was formed under stirring. The lithium hydroxide concentration therein was 0.5 mol/L and the hydrogen peroxide concentration was 1.0 mol/L. Then, the clear yellow solution was heated to 90° C. and kept at constant temperature under stirring for 4 hours, the reaction was terminated, and a white solid was obtained after separation. Subsequently, the above white solid was dried and placed in an oven at 180° C. for annealing treatment for 24 hours to remove any hydrogen peroxide adsorbed or included in the white solid. Then, the treated white solid was washed with deionized water for several times and placed in a 0.01 mol/L nitric acid solution for hydrogen ion exchange. After hydrogen ion exchange, the solid was washed with deionized water for several times until the pH of the washing solution was close to neutral and then dried.

Finally, the dried white solid was dispersed into 100 ml of pure water, and a hydrothermal reaction was carried out at 160° C. for 24 hours to obtain an anatase phase linear porous titanium dioxide material.

### EXAMPLE 6

This example provides a method of preparing a linear porous titanium dioxide material, which comprises the following steps:

Under stirring, 1.5 g of titanium ethoxide was dispersed in 100 ml of an aqueous solution prepared by dissolving hydrogen peroxide and lithium hydroxide in water, and a clear yellow solution was formed under stirring. The lithium hydroxide concentration therein was 0.7 mol/L and the hydrogen peroxide concentration was 0.8 mol/L. Then, the clear yellow solution was heated to 100° C. and kept at constant temperature under stirring for 2 hours, the reaction was terminated, and a white solid was obtained after separation. Subsequently, the above white solid was dried and placed in an oven at 230° C. for annealing treatment for 10 hours to remove any hydrogen peroxide adsorbed or included in the white solid. Then, the treated white solid was washed with deionized water for several times and placed in a 0.05 mol/L hydrochloric acid solution for hydrogen ion exchange. After hydrogen ion exchange, the solid was washed with deionized water for several times until the pH of the washing solution was close to neutral and then dried.

Finally, the dried white solid was dispersed into 100 ml of an aqueous solution of nitric acid at a concentration of 0.01 mol/L, and a hydrothermal reaction was carried out at 200° C. for 10 hours to obtain an anatase phase linear porous titanium dioxide material.

### EXAMPLE 7

This example provides a method of preparing a linear porous titanium dioxide material, which comprises the following steps:

Under stirring, 2 g of tetrabutyl titanate was dispersed in 100 ml of an aqueous solution for direct hydrolysis to form a titanic acid hydrate precipitate, and the titanic acid hydrate precipitate was ultrasonically dispersed, washed with deionized water for several times, and then separated by centrifugation.

Next, hydrogen peroxide and lithium hydroxide were dissolved in water to a lithium hydroxide concentration of 0.8 mol/L and a hydrogen peroxide concentration of 0.9 mol/L. Subsequently, the above titanic acid hydrate precipitate upon centrifugation was dispersed in 100 ml of the hydrogen peroxide aqueous solution containing lithium hydroxide prepared as above, and a clear yellow solution was formed under stirring. Then, the clear yellow solution was heated to 80° C. and kept at constant temperature under stirring for 8 hours, the reaction was terminated, and a white solid was obtained after separation. Subsequently, the above white solid was dried and placed in an oven at 200° C. for annealing treatment for 24 hours to remove any hydrogen peroxide adsorbed or included in the white solid. Then, the treated white solid was washed with deionized water for several times and placed in a 0.01 mol/L sulfuric acid solution for hydrogen ion exchange. After hydrogen ion exchange, the solid was washed with deionized water for several times until the pH of the washing solution was close to neutral and then dried.

Finally, the dried white solid was dispersed into 100 ml of an aqueous solution of hydrofluoric acid at a concentration of 0.01 mol/L, and a hydrothermal reaction was carried out at 105° C. for 48 hours to obtain an anatase phase linear porous titanium dioxide material.

### EXAMPLE 8

This example provides a method of preparing a linear porous titanium dioxide material, which comprises the following steps:

Under stirring, 2 g of titanium glyceroxide was dispersed in 100 ml of an aqueous solution for direct hydrolysis to form a titanic acid hydrate precipitate, and the titanic acid hydrate precipitate was ultrasonically dispersed, washed with deionized water for several times, and then separated by centrifugation.

Next, hydrogen peroxide and lithium superoxide were dissolved in water to a lithium hydroxide concentration of 0.7 mol/L and a hydrogen peroxide concentration of 0.8 mol/L. Subsequently, the above titanic acid hydrate precipitate upon centrifugation was dispersed in 100 ml of the hydrogen peroxide aqueous solution containing lithium hydroxide prepared as above, and a clear yellow solution was formed under stirring. Then, the clear yellow solution was heated to 80° C. and kept at constant temperature under stirring for 10 hours, the reaction was terminated, and a white solid was obtained after separation. Subsequently, the above white solid was dried and placed in an oven at 250° C. for annealing treatment for 4 hours to remove any hydrogen peroxide adsorbed or included in the white solid. Then, the treated white solid was washed with deionized water for several times and placed in a 0.01 mol/L nitric acid solution for hydrogen ion exchange. After hydrogen ion exchange, the solid was washed with deionized water for several times until the pH of the washing solution was close to neutral and then dried.

Finally, the dried white solid was dispersed into 100 ml of an aqueous solution of diethylamine at a concentration of 0.0001 mol/L, and a hydrothermal reaction was carried out at 240° C. for 1 hour to obtain an anatase phase linear porous titanium dioxide material.

### EXAMPLE 9

This example provides a method of preparing a linear porous titanium dioxide material, which comprises the following steps:

Under stirring, 2 g of tetrabutyl titanate was dispersed in 100 ml of an aqueous solution for direct hydrolysis to form a titanic acid hydrate precipitate, and the titanic acid hydrate precipitate was ultrasonically dispersed, washed with deionized water for several times, and then separated by centrifugation.

Next, hydrogen peroxide and lithium hydroxide were dissolved in water to a lithium hydroxide concentration of 0.8 mol/L and a hydrogen peroxide concentration of 0.9 mol/L. Subsequently, the above titanic acid hydrate precipitate upon centrifugation was dispersed in 100 ml of the hydrogen peroxide aqueous solution containing lithium hydroxide prepared as above, into which polyethylene glycol with a content of 0.5% was added, and a clear yellow solution was formed under stirring. Then, the clear yellow solution was heated to 80° C. and kept at constant temperature under stirring for 8 hours, the reaction was terminated, and a white solid was obtained after separation. Subsequently, the above white solid was dried and placed in an oven at 200° C. for annealing treatment for 24 hours to remove any hydrogen peroxide adsorbed or included in the white solid. Then, the treated white solid was washed with deionized water for several times and placed in a 0.01 mol/L sulfuric acid solution for hydrogen ion exchange. After hydrogen ion exchange, the solid was washed with deionized water for several times until the pH of the washing solution was close to neutral and then dried.

Finally, the dried white solid was dispersed into 100 ml of an aqueous solution of hydrofluoric acid at a concentration of 0.01 mol/L, and a hydrothermal reaction was carried out at 180° C. for 12 hours to obtain an anatase phase linear porous titanium dioxide material.

### EXAMPLE 10

This example provides a method for surface modification of a linear porous titanium dioxide material, which comprises the following steps:

Under stirring, 1 g of titanium sulfate was dispersed and dissolved under stirring in 100 ml of an aqueous solution to form a solution, and aqueous ammonia at a concentration of 0.1 mol/L was slowly added dropwise to the above solution until the solution was neutral (about pH 7). The titanium sulfate was gradually and completely hydrolyzed to form a titanic acid hydrate precipitate, and the titanic acid hydrate precipitate was ultrasonically dispersed, washed with deionized water for several times, and then separated by centrifugation.

Next, hydrogen peroxide and lithium hydroxide were dissolved in water to a lithium hydroxide concentration of 0.6 mol/L and a hydrogen peroxide concentration of 0.8 mol/L. Subsequently, the above titanic acid hydrate precipitate upon centrifugation was dispersed in 100 ml of the hydrogen peroxide aqueous solution containing lithium hydroxide prepared as above, and a clear yellow solution was formed under stirring. Then, this clear yellow solution was heated to 80° C. and kept at constant temperature under stirring for 6 hours, the reaction was terminated, and a white solid was obtained after separation. Subsequently, the above white solid was dried and placed in an oven at 220° C. for annealing treatment for 12 hours to remove any hydrogen peroxide adsorbed or included in the white solid. Then, the treated white solid was washed with deionized water for several times and placed in a 0.01 mol/L nitric acid solution for hydrogen ion exchange. After hydrogen ion exchange, the solid was washed with deionized water for several times until the pH of the washing solution was close to neutral and then dried.

Finally, the dried white solid was dispersed in 100 ml of an aqueous solution containing graphene oxide at a mass fraction of 500 ppm, and a hydrothermal reaction was carried out at 180° C. for 12 hours to obtain a graphene-loaded anatase phase linear porous titanium dioxide material.

### EXAMPLE 11

This example provides a method for surface modification of a linear porous titanium dioxide material, which comprises the following steps:

Under stirring, 1 g of titanium sulfate was dispersed and dissolved under stirring in 100 ml of an aqueous solution to form a solution, and aqueous ammonia at a concentration of 0.1 mol/L was slowly added dropwise to the above solution until the solution was neutral (about pH 7). The titanium sulfate was gradually and completely hydrolyzed to form a titanic acid hydrate precipitate, and the titanic acid hydrate precipitate was ultrasonically dispersed, washed with deionized water for several times, and then separated by centrifugation.

Next, hydrogen peroxide and lithium hydroxide were dissolved in water to a lithium hydroxide concentration of 0.6 mol/L and a hydrogen peroxide concentration of 0.8 mol/L. Subsequently, the above titanic acid hydrate precipitate upon centrifugation was dispersed in 100 ml of the hydrogen peroxide aqueous solution containing lithium hydroxide prepared as above, and a clear yellow solution was formed under stirring. Then, this clear yellow solution was heated to 80° C. and kept at constant temperature under stirring for 6 hours, the reaction was terminated, and a white solid was obtained after separation. Subsequently, the above white solid was dried and placed in an oven at 220° C. for annealing treatment for 12 hours to remove any hydrogen peroxide adsorbed or included in the white solid. Then, the treated white solid was washed with deionized water for several times and placed in a 0.01 mol/L nitric acid solution for hydrogen ion exchange. After hydrogen ion exchange, the solid was washed with deionized water for several times until the pH of the washing solution was close to neutral and then dried.

The dried white solid was dispersed in 100 ml of an aqueous solution containing nickel acetate at a mass fraction of 1,000 ppm, and then separated and dried.

Finally, the separated and dried solid power was placed in a muffle furnace and annealed at 600° C. for 4 hours to obtain a nickel oxide-loaded anatase phase linear porous titanium dioxide material.

### EXAMPLE 12

This example provides a method for semiconductor compositing of a linear porous titanium dioxide material, which comprises the following steps:

Under stirring, 1 g of titanium sulfate was dispersed and dissolved under stirring in 100 ml of an aqueous solution to form a solution, and aqueous ammonia at a concentration of 0.1 mol/L was slowly added dropwise to the above solution until the solution was neutral (about pH 7). The titanium sulfate was gradually and completely hydrolyzed to form a titanic acid hydrate precipitate, and the titanic acid hydrate precipitate was ultrasonically dispersed, washed with deionized water for several times, and then separated by centrifugation.

Next, hydrogen peroxide and lithium hydroxide were dissolved in water to a lithium hydroxide concentration of 0.6 mol/L and a hydrogen peroxide concentration of 0.8 mol/L. Subsequently, the above titanic acid hydrate precipitate upon centrifugation was dispersed in 100 ml of the hydrogen peroxide aqueous solution containing lithium hydroxide prepared as above, and a clear yellow solution was formed under stirring. Then, this clear yellow solution was heated to 80° C. and kept at constant temperature under stirring for 6 hours, the reaction was terminated, and a white solid was obtained after separation. Subsequently, the above white solid was dried and placed in an oven at 220° C. for annealing treatment for 12 hours to remove any hydrogen peroxide adsorbed or included in the white solid. Then, the treated white solid was washed with deionized water for several times and placed in a 0.01 mol/L nitric acid solution for hydrogen ion exchange. After hydrogen ion exchange, the solid was washed with deionized water for several times until the pH of the washing solution was close to neutral and then dried.

The dried white solid was dispersed in 100 ml of an aqueous solution containing copper acetate at a mass fraction of 5,000 ppm, and then separated and dried.

Finally, the separated and dried solid power was placed in a muffle furnace and annealed at 650° C. for 3 hours to obtain a composite material of a copper oxide semiconductor and anatase phase linear porous titanium dioxide.

### EXAMPLE 13

This example provides a method for semiconductor compositing of a linear porous titanium dioxide material, which comprises the following steps:

1 g of titanium sulfate was dispersed and dissolved under stirring in 100 ml of an aqueous solution to form a solution, and aqueous ammonia at a concentration of 0.1 mol/L was slowly added dropwise to the above solution until the solution was neutral (about pH 7). The titanium sulfate was gradually and completely hydrolyzed to form a titanic acid hydrate precipitate, and the titanic acid hydrate precipitate was ultrasonically dispersed, washed with deionized water for several times, and then separated by centrifugation.

Next, hydrogen peroxide and lithium hydroxide were dissolved in water to a lithium hydroxide concentration of 0.6 mol/L and a hydrogen peroxide concentration of 0.8 mol/L. Subsequently, the above titanic acid hydrate precipitate upon centrifugation was dispersed in 100 ml of the hydrogen peroxide aqueous solution containing lithium hydroxide prepared as above, and a clear yellow solution was formed under stirring. Then, this clear yellow solution was heated to 80° C. and kept at constant temperature under stirring for 6 hours, the reaction was terminated, and a white solid was obtained after separation. Subsequently, the above white solid was dried and placed in an oven at 220° C. for annealing treatment for 12 hours to remove any hydrogen peroxide adsorbed or included in the white solid. Then, the treated white solid was washed with deionized water for several times and placed in a 0.01 mol/L nitric acid solution for hydrogen ion exchange. After hydrogen ion exchange, the solid was washed with deionized water for several times until the pH of the washing solution was close to neutral and then dried.

The dried white solid was mixed with 0.5 g urea by grinding and then placed in a muffle furnace and annealed at 550° C. for 3 hours to obtain a composite material of a carbon nitride semiconductor and anatase phase linear porous titanium dioxide.

It is to be understood that the above description is for the purpose of illustration, but not for limitation. Various embodiments and various applications other than the examples as provided will be apparent to those skilled in the art after reading the above description. Thus, the scope of the present invention should not be determined with reference to the above description, but dictated by the overall scope with reference to the claims and equivalents encompassed by the claims. For all purposes, all literatures and references, including disclosure of patent applications and publications, are hereby incorporated by reference in its entirety. The omission in the following claims of any aspects of a subject matter disclosed herein is not intended to be an exclusion of this subject matter, and it should not be construed that this subject matter is not contemplated by the inventor as part of the inventive subject matters disclosed herein.

What is claimed is:

1. A linear porous titanium dioxide material, wherein the linear porous titanium dioxide material has an anatase phase structure and a single crystal structure;
the structure of the linear porous titanium dioxide material is composed of a plurality of particles having an oriented growth direction, preferably a growth direction in the <001> direction.

2. The linear porous titanium dioxide material according to claim 1, wherein the linear porous titanium dioxide material has a structure of one or more rectangular columns which have flat side surfaces that are perpendicular to each other.

3. The linear porous titanium dioxide material according to claim 1, wherein the side surfaces of the linear porous titanium dioxide material are highly-active anatase phase {100} and {001} crystal planes.

4. The linear porous titanium dioxide material according to claim 1, wherein the linear porous titanium dioxide material has a linear structure having a diameter of 20 nm to 5 μm and a length of 1 μm to 50 μm.

5. The linear porous titanium dioxide material according to claim 1, wherein the linear porous titanium dioxide material has a linear structure having a diameter of 100 nm to 1,000 nm and a length of 5 μm to 20 μm.

6. The linear porous titanium dioxide material according to claim 1, wherein the pores in the linear porous structure of the linear porous titanium dioxide material have a size of 2 nm to 50 nm.

7. The linear porous titanium dioxide material according to claim 6, wherein the pores have a size of 5 nm to 20 nm.

8. The linear porous titanium dioxide material according to claim 1, wherein the long-axis of the single crystal of the linear porous titanium dioxide material is oriented in the <010> direction.

9. A method of preparing a linear porous titanium dioxide material according to claim 1, wherein the preparation method comprises:
dispersing a titanium source in an aqueous solution of a peroxide containing a lithium compound under stirring to form a solution;
subjecting the solution to a heating reaction to obtain lithium titanate peroxide having a linear structure;
subjecting the lithium titanate peroxide to a low temperature annealing treatment to obtain lithium titanate having a linear structure;
dispersing the lithium titanate in an acid solution for hydrogen ion exchange to obtain titanic acid having a linear structure; and
subjecting the titanic acid to heat treatment to obtain the linear porous titanium dioxide material;
wherein the titanium source is one or more selected from titanium ethoxide, titanium propoxide, tetrabutyl titanate, titanium glycolate, titanium glyceroxide, titanium sulfate, titanium oxysulfate, titanium tetrachloride, titanium tetrafluoride, ammonium fluorotitanate, titanium nitride, titanium dioxide, metatitanic acid or orthotitanic acid; or
the titanium source is selected from titanic acid hydrate; and the titanic acid hydrate is obtained by a hydrolysis reaction of a titanium-containing compound, wherein the titanium-containing compound is one or more selected from titanium ethoxide, titanium propoxide, tetrabutyl titanate, titanium glycolate, titanium glyceroxide, titanium sulfate, titanium oxysulfate, titanium tetrachloride, titanium tetrafluoride or ammonium fluorotitanate; the hydrolysis reaction is conducted by dispersing the titanium-containing compound in pure water for direct hydrolysis to produce the titanic acid hydrate; alternatively, the hydrolysis reaction is conducted by dispersing the titanium-containing compound in an aqueous solution containing an alkali substance for hydrolysis to produce the titanic acid hydrate.

10. The preparation method according to claim 9, wherein a polymer is added to the solution while the titanium source is being dispersed in an aqueous solution of a peroxide containing a lithium compound under stirring to form a solution;
wherein the polymer is one or more selected from chitosan, guar gum, methyl cellulose, ethyl cellulose, hydroxyethyl cellulose, hydroxypropyl cellulose, hydroxypropyl methyl cellulose, polyvinyl alcohol, polyacrylamide, polyethylene oxide, polyethylene glycol or polyvinylpyrrolidone;
the mass fraction of the polymer in the solution is 100 ppm to 100,000 ppm.

11. The preparation method according to claim 9, wherein the titanic acid hydrate is obtained by purification after the hydrolysis reaction of the titanium-containing compound; the purification is done to remove impurity ions to obtain a titanic acid hydrate with a purity of 97% or more; the purification is conducted in a manner of one or more of water washing-centrifuge separation, water washing-membrane separation, water washing-filtration, and dialysis.

12. The preparation method according to claim 9, wherein the lithium compound in the aqueous solution of the lithium compound-containing peroxide is one or more selected from lithium hydroxide, lithium oxide, lithium peroxide or lithium superoxide; the concentration of the lithium compound is 0.4 to 1.0 mol/L;
wherein in the aqueous solution of the lithium compound-containing peroxide, the peroxide is one or more selected from hydrogen peroxide, urea peroxide or peracetic acid; the concentration of the peroxide is 0.1 to 2.0 mol/L.

13. The preparation method according to claim 9, wherein the temperature of the heating reaction is 60 to 100° C.; and the duration of the heating reaction is 0.5 to 24 hours.

14. The preparation method according to claim 9, wherein the temperature of the low temperature annealing treatment is 150 to 250° C.; and the duration of the low temperature annealing treatment is 1 to 24 hours.

15. The preparation method according to claim 9, wherein the hydrogen ion exchange includes:
washing and separating the lithium titanate having a linear structure;
adding the separated lithium titanate having a linear structure in an acid solution for hydrogen ion exchange to obtain a titanic acid having a linear structure, and washing the titanic acid having a linear structure before being separated and dried.

16. The preparation method according to claim 15, wherein the acid solution is one or more selected from nitric acid, hydrochloric acid, sulfuric acid or acetic acid; wherein the concentration of the acid solution is 0.001 to 0.1 mol/L.

17. The preparation method according to claim 9, wherein the heat treatment includes hydrothermal treatment and/or high temperature annealing;
wherein the temperature of the hydrothermal reaction is 105 to 240° C.; and the duration of the hydrothermal reaction is 1 to 48 hours; and the system of the hydrothermal reaction is one of an acidic system, a neutral system, and an alkaline system;
wherein the temperature of the high temperature annealing is 300 to 1000° C., preferably from 350 to 1000° C.; and the duration of the high temperature annealing treatment is 1 to 24 hours.

18. A method for surface modification of a linear porous titanium dioxide material according to claim 1;
wherein the surface modification comprises one or more of carbon loading, graphene loading, black phosphorus loading, ruthenium oxide loading, lead oxide loading, nickel oxide loading, metal platinum loading, metal gold loading, metal silver loading, and metal copper loading.

19. A method for semiconductor compositing of a linear porous titanium dioxide material according to claim 1;
wherein the semiconductor compositing includes one or more of semiconductor compositing with cadmium sulfide, cadmium sulfide-semiconductor compositing, lead sulfide-semiconductor compositing, copper oxide-semiconductor compositing, cuprous oxide-semiconductor compositing, iron oxide-semiconductor compositing, ferrous oxide-semiconductor compositing, tungsten oxide-semiconductor compositing, zinc oxide-semiconductor compositing, gallium phosphide-semiconductor compositing, cadmium stannide-semiconductor compositing, molybdenum sulfide-semiconductor compositing, and carbon nitride-semiconductor compositing.

20. Use of the linear porous titanium dioxide material according to claim 1 in the field of one or more of lithium ion battery materials, sodium ion battery materials, potassium ion battery materials, catalytic hydrogenation materials, organic pollutant photocatalytic degradation, water photocatalytic decomposition for hydrogen production, gas sensing, dye-sensitized solar cells, perovskite solar cells, hydrophilic and hydrophobic materials, and biomedicines.
